(19) United States
(12) Patent Application Publication
(10) Pub. No.: US 2010/0301290 A1
(43) Pub. Date: Dec. 2, 2010

(54) ELECTRICALLY-OPERATED ASSIST DEVICE FOR RAISING UPPER BODY

(76) Inventor: Yukihiro Sugawara, Tokyo (JP)

Correspondence Address: Yukihiro Sugawara, Komagome hights 305, 3-21-8 Honkomagome, Bunkyoku, Tokyo, 113 - 0021, JP

(21) Appl. No.: 12/475,520

(22) Filed: May 31, 2009

(51) Int. Cl. B66F 3/10; B66F 3/00

(52) U.S. Cl. 254/96; 254/213

(57) ABSTRACT

An electrically-operated assist device for raising an upper is disclosed. The assist device includes a pipe member of a predetermined length and having a handgrip or a shoulder belt and a sliding pipe inserted into the pipe member and having a hooking member in one end portion. The assist device further includes a nut in the other end portion, a motor disposed in one end portion of the pipe member, a threaded rod mounted to a drive shaft of the pipe member and threadably engaged with the nut; and an operating switch for said motor.

### CROSS-REFERENCE TO RELATED APPLICATION

This application is entitled to the benefit of Provisional Patent Application No. 61/130,939, filed Jun. 5, 2008.

### BACKGROUND

The present invention relates to an electrically-operated assist device for raising an upper body (hereinafter also referred to as “assist device for sitting up”) with which an aged person who has suffered from serious injuries such as requires hospitalization or who is bedridden can raise his/her upper body at will even without any nearby person.

It has been difficult for bedridden people due to injury, illness or the like to raise their upper body in bed. Especially bedridden people due to old age cannot sit up without assist from their family member, nurse or any other nearby person.

Thus, in order for them to sit up by themselves, a bed the upper body portion of which can be raised with a motor has been provided as a bed targeting at bedridden people or serious patients in a hospital. In addition, a technology of the assist device has been provided which allows to raise the upper body from lying down position by attaching a grip member to an end of a rope and taking up the other end of the lope into a motor pulley in a driving box via a relay pulley. Refer, for example, to Japanese laid-open patent publication Heisei 9-149919.

Furthermore, there exists a technology of a sitting up assist device which allows to raise the upper body together with a Japanese-style bedding by disposing under the bedding a device the back face member of which can support the upper body of the person lying on the bedding, and gradually rises by an electric motor and then turning it on. Refer, for example, to Japanese laid-open patent publication Heisei 9-154895

Even those in hospital due to injuries or bedridden as mentioned above have to do various small-sized daily things like drinking tea, picking up tissue paper, operating a TV set or the like. It is quite difficult for them to raise their upper body and do any of such things by themselves; many of them cannot sit up without assist from a nearby person and so they have to be patient when they are alone, which is often stressful to them.

The afore-mentioned technology disclosed in Japanese laid open patent publication Heisei 9-149919 relates to the sitting up assist device which allows to raise the upper body alone by attaching a grip member to one end of a rope and taking up the other end into a motor pulley in a driving box via a relay pulley. However, this device has drawbacks and inconveniences including one that, since this device requires the relay pulley to be fixed to a pillar or wall, it cannot be used where there is no place for fixing.

The technology according to Japanese laid open patent publication Heisei 9-154895 relates to a sitting up assist device in which a back plate member capable of supporting the upper body has rocking links disposed on both ends of the back plate member and is rotatably supported by a bearing bracket; at the same time, a motor is disposed along the extension of the rocking links with a threaded axis attached to the drive shaft of the motor and a locked nut member engaged thereto. Thus, when the motor is actuated, the nut member proceeds and presses the rocking links to cause the aforementioned back plate member to stand up so as to raise the back portion of the lying person together with the bedding. Therefore, it is relatively compact compared with the system which is integrally embedded in a bed. In addition, since it is equipped with casters, it can be moved to a different room. However, it still has the inconveniences and unmanageability shown below.

First of all, though this device will be convenient if it is used for only Japanese-style bedding due to its compact formation, it has inconveniences, for example, that it may not be used as is for a bed, depending on the thickness and base of the bed. Furthermore, in spite of its compactness, it is of high cost of production since it comprises a certain size of frame and a motor as well as various components, which causes inconveniences, for example, that it is too expensive for all the people to use it without hesitation.

Additionally, though it is of no problem to use it for a completely bedridden aged person, an ordinary aged person needs to put away this device together with the Japanese-style bedding after getting up every morning and set up the bedding on this device before bedtime. Even though the device is equipped with casters, it is very annoying and burdensome in weight for an aged person to repeat these tasks everyday. Furthermore, since the device rises up together with the bedding and so causes the pillow to fall down on actuating its sitting up operation, it has inconveniences, for example, that it is hard for an aged person without a support person or the like.

### SUMMARY OF THE INVENTION

According to one aspect of the present invention, there is provided an electrically-operated assist device for raising an upper body comprising a pipe member of a predetermined length, the pipe member having a handgrip or a shoulder belt, a sliding pipe inserted into the pipe member, the sliding pipe having a hooking member in one end portion and a nut in the other end portion, a motor disposed in one end portion of the pipe member, a threaded rod mounted to a drive shaft of the pipe member, the threaded rod being threadably engaged with the nut; and an operating switch for the motor.

According to another aspect of the present invention, there is provided an electrically-operated assist device for raising an upper body comprising a pipe member of a predetermined length, the pipe member having a handgrip or a shoulder belt, a motor disposed in an end portion of the pipe member, the motor having a winch, a sliding pipe inserted into the pipe member, the sliding pipe having a hooking member in one end portion and connected to the pipe member by a wire of the winch, a coil spring disposed between the pipe member and the sliding pipe; and a operating switch for the motor.

According to still another aspect of the present invention, An electrically-operated assist device for raising an upper body comprising a pipe member of a predetermined length, the pipe member having a hooking member at one end, a motor mounted to one end portion of the pipe member, a threaded rod mounted to a drive shaft of the motor, a nut threadably engaged with the threaded rod, a handgrip mounted to the nut through a slot of nearly the same length of the threaded rod, the slot being formed in an upper portion of the pipe member, and an operating switch for the motor.

In the first and second aspects as shown above, the operating switch may be disposed on the pipe member.

In the third aspect as shown above, the operating switch may be disposed on the nut.

### BRIEF DESCRIPTION OF THE DRAWINGS

Features of the present invention will become apparent to those skilled in the art from the following description with reference to the figures, in which:

FIG. 1 is a perspective view showing the first embodiment of the assist device for raising an upper body of the invention;

FIG. 2 is a transverse sectional view showing the main body of the assist device for sitting up of the first embodiment;

FIG. 3 is an enlarged A-A sectional view showing the main body of the assist device for sitting up of the first embodiment;

FIG. 4 is a reference view showing the manner of use of the assist device for sitting up of the first embodiment;

FIG. 5 is a perspective view showing the main body of the assist device for sitting up of the second embodiment;

FIG. 6 is a longitudinal sectional view of the assist device for sitting up of the second embodiment;

FIG. 7 is a perspective view showing the assist device for sitting up of the third embodiment; and

FIG. 8 is a longitudinal sectional view of the assist device for sitting up of the third embodiment.

### DETAILED DESCRIPTION

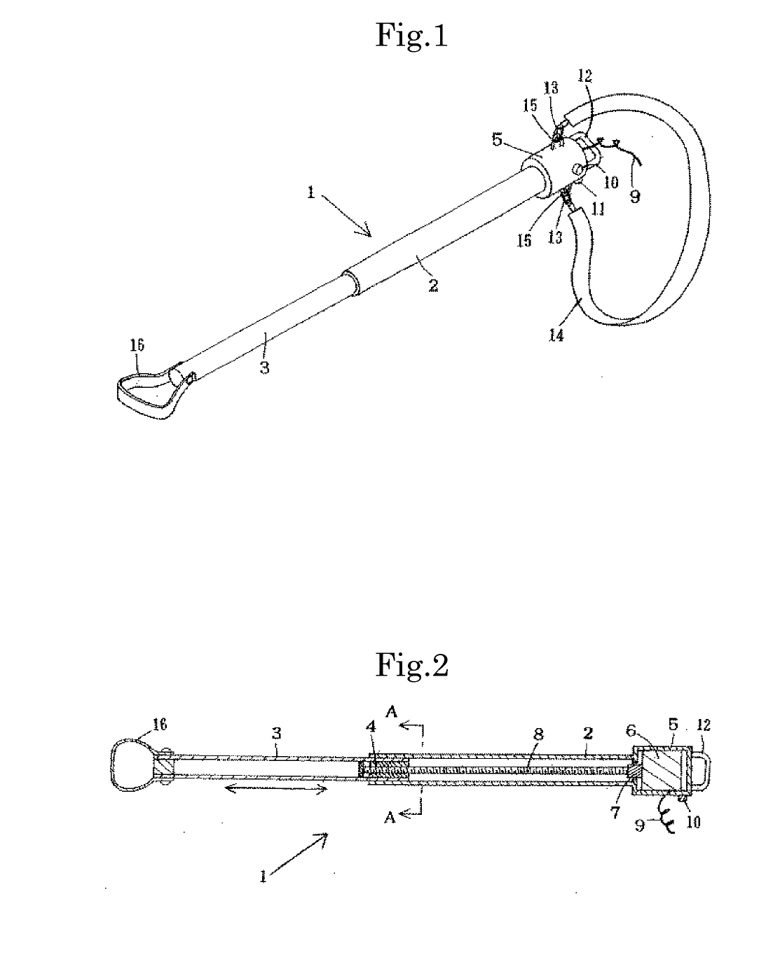

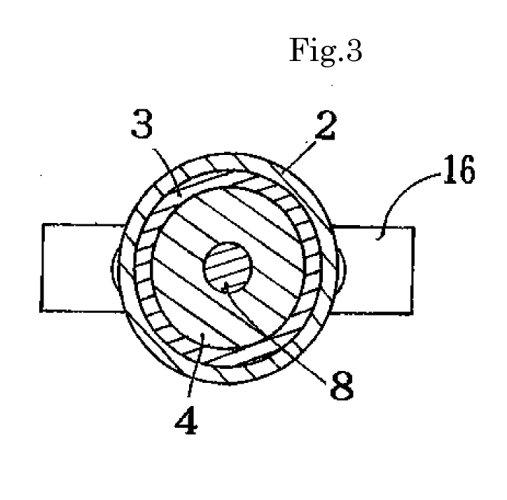

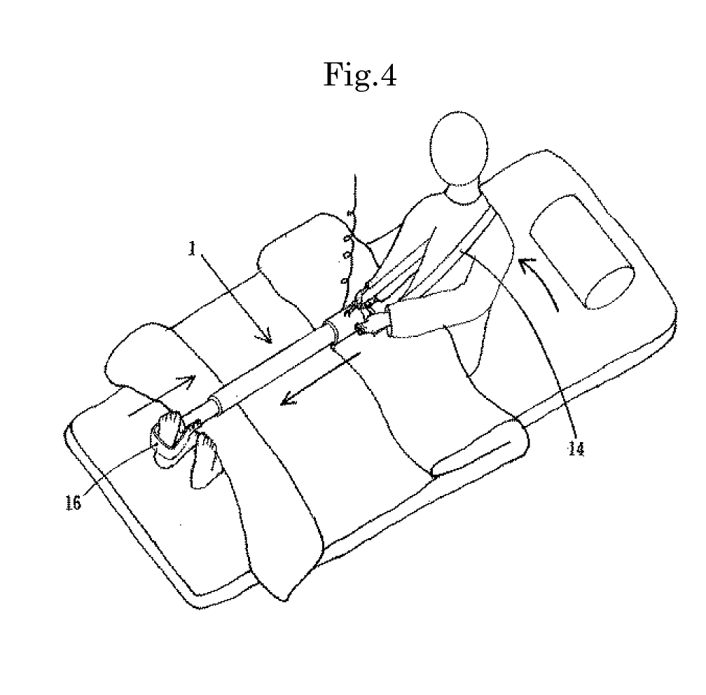

The assist device for sitting up according to the first embodiment of the present invention will be explained with reference to the perspective view shown in FIG. 1, the transverse sectional view of the main body of the assist device for sitting up shown in FIG. 2, the enlarged A-A sectional view shown in FIG. 3, and the reference view showing the manner of use of the assist device for sitting up shown in FIG. 4.

The assist device for sitting up 1 of the first embodiment is made essentially of light-weight and tough metallic material such as aluminum. The main body of the assist device for sitting up 1 comprises an actuator mechanism which includes a pipe member 2 of a predetermined length of about a half of the distance between the hand and the foot of a human body in a lying posture and a sliding pipe 3 containing a nut 4 in one end portion thereof. The end portion having the nut 4 of the sliding pipe 4 is slidably inserted into the pipe member 2 so that the combination of the pipe member 2 and the sliding pipe 4 is retractable. A motor housing 5 is disposed in one end of the pipe member 2 that is opposite to the end into which the sliding pipe 4 is inserted. A motor 6 disposed in the motor housing 5 contains a speed reducer (not shown) therein which is electric or has a combination of gears, and one end of a threaded rod 8 of the length that is about the same as the length of the pipe member 2 is connected to a drive shaft of the motor 6. The other end of the threaded rod 8 is engaged with the nut 4 in the sliding pipe 3 so that the sliding pipe 3 can be move in and out of the pipe member 2.

The assist device for sitting up 1 further comprises a power cable 9, an operating switch 10, a selector switch 11 that can make a selection between forward rotation and backward rotation, and a handgrip 12. An annular belt-like hooking member 16 is mounted at the end of the sliding pipe 3 with two hooks 15, 15 mounted thereon. A shoulder belt to be put around the human body 14 has snap hooks 18 so that it can be hooked and fixed to the two hooks 15, 15. Though the aforementioned selector switch 11 and operating switch 10 are separately disposed, the selector switch 11 may be integrally disposed with the operating switch. Further, the hooking member 16 may be a thick string instead of a belt.

Since the assist device for sitting up 1 shown as the first embodiment is equipped with the motor 6 having the threaded rod 8 at one end of the pipe member 2 and the sliding pipe 3 having the nut 4 is slidably engaged with the threaded rod 8. Thus, when you hook your foot in the hooking member 16, clutch the handgrip 12 or put the shoulder belt 14 around your body as shown in FIG. 4 and then you actuate the operating switch 10, the sliding pipe 3 is retracted as the threaded rod 8 engaged with the nut 4 rotates, causing your upper body to be automatically raised with the handgrip 12 or the shoulder belt 14 kept clutched; the reverse rotation of the threaded rod 8 caused by actuating the selector switch 11 can lay your upper body down.

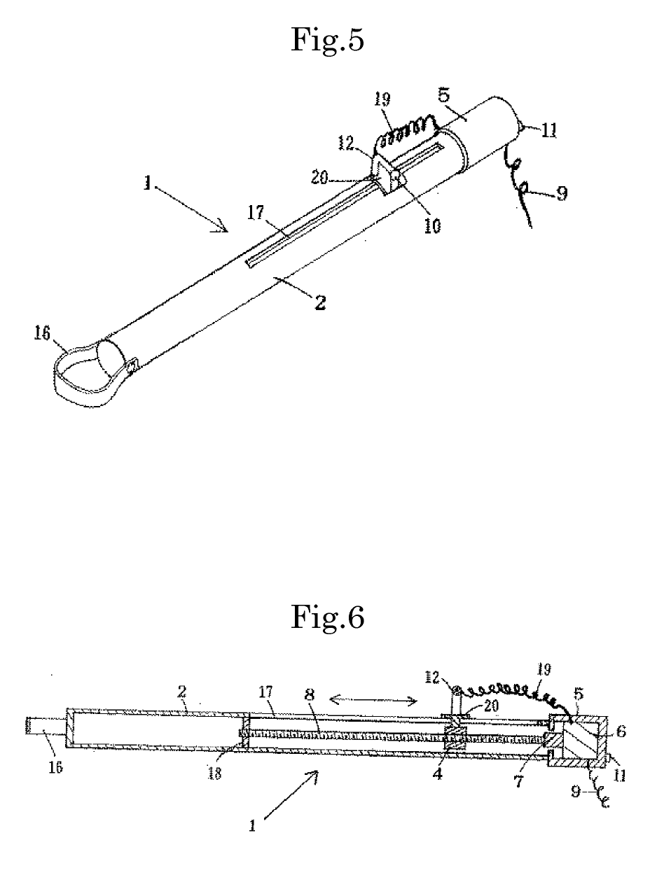

The assist device for sitting up according to the second embodiment will be explained with reference to the perspective view shown in FIG. 5 and the longitudinal sectional view shown in FIG. 6.

The main body of an assist device for sitting up 1 comprises an actuator mechanism which includes a pipe member 2 of the length about twice as long as in the first embodiment. A slot 17 of a certain length extends along the upper portion of the pipe member 2 and is biased toward the rear portion of the pipe member 2. A threaded rot 8 of about the same length of the slot 17 is mounted to a drive shaft 7 of a motor 6 housed in a motor housing 5 disposed near one end of the slot 17. The threaded rod 8 is engaged with a nut 4 and one end of the threaded rod 8 is rotatably held by a shaft plate 18. A base plate 20 with a handgrip 12 connected thereto is mounted to the nut 4 through the slot 17. The handgrip 12 has a operating switch which is wired to the motor 6 by a lead wire 19. An annular belt-like hooking member 16 is mounted to the anterior end of the pipe member 2. A power cable 9 and a selector switch 11 is disposed in the motor housing 5.

Since the main body of the assist device for sitting up 1 as shown as the second embodiment is of a single-piece type and the nut 4 with the handgrip 12 located in the slot 17 disposed on the upper portion of the pipe member 2 is engaged with the threaded rod 8, it can raise up and lay down the upper body by the forward and backward movement of the nut 4 and the handgrip 12 in an interlocking manner with the rotation of the threaded rod 8. Though the lead wire 19 running from the motor 6 to the handgrip 12 is wired along the exterior of the pipe member 2, it may be wired in the pipe member 2.

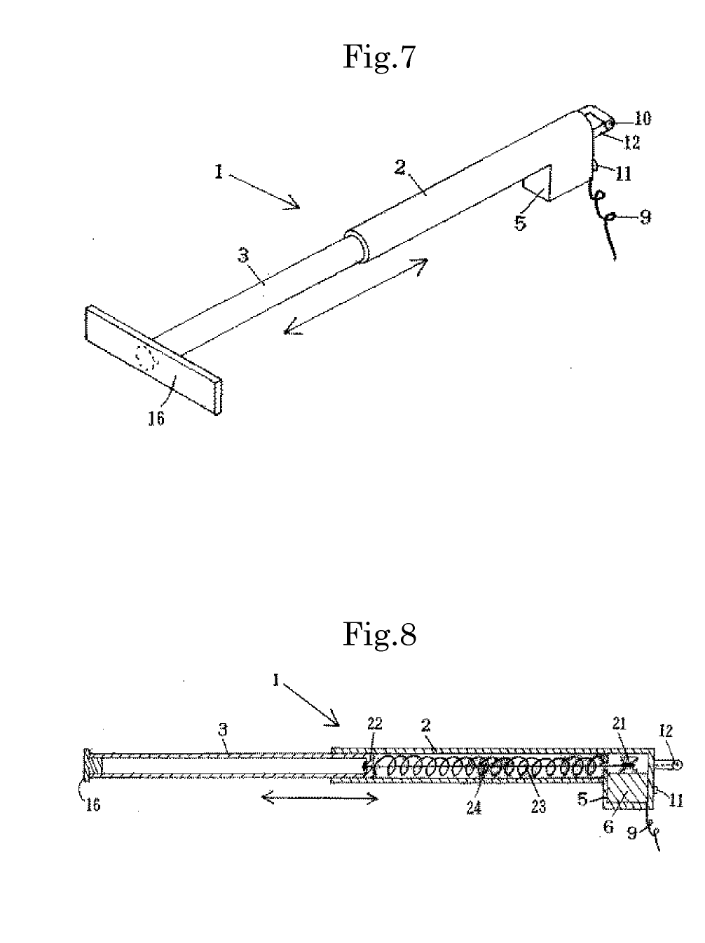

The assist device for sitting up according to the third embodiment will be explained with reference to the perspective view shown in FIG. 7 and the longitudinal sectional view shown in FIG. 8.

Though the assist device for sitting up 1 according to the third embodiment is of the type in which the sliding pipe 3 engaged with the pipe member 2 expands and contracts just as in the first embodiment, its sliding means is a winching system. The assist device for sitting up 1 comprises a motor housing 5 containing a motor 6 with a winch 21 at one end of the pipe member 2 with its drive shaft (not shown) located perpendicular to the end of the pipe member 2. A power cable 9, a handgrip 12 with an operating switch 10 and a selector switch 11 is disposed in the motor housing 5. A plate is mounted to one end the sliding pipe 3 in T-shape to form a hooking member. To the other end of the sliding pipe 3 is mounted a lid plate 22 and the end portion of the sliding pipe 3 having the lid plate 22 is slidably inserted into the pipe member 2 and the lid plate 22 is connected to the winch 21 by a wire 24 which runs inside of a coil spring 23. Though the hooking member 16 attached to the end of the sliding pipe 3 is mounted in T-shape, it may be in L-shape in which it expends only in a single direction.

The rear portion of the sliding pipe 3 that is slidably engaged with the pipe member 2 is connected to the winch 16 by the wire 24 with the coil spring in the assist device for sitting up according to the third embodiment. Thus, on actuating the motor 6, the sliding pipe 3 retracts in an interlocking manner as the wire 24 is taken up by the winch 21, which in turn moves forward the pipe member 2 the handgrip 12 of which is gripped by the use, allowing the user to raise his/her body; on the reverse rotation of the motor 6, the coil sprint 23 pushes the sliding pipe 3 out as the wire 24 comes loose, which causes the similar effects as with the first embodiment described as above.

Though the present invention is configured as above, the shoulder belt 14 which is incorporated in the first embodiment may be omitted; the other embodiments may incorporate the shoulder belt 14. Furthermore, though the hooking member 16 is annular belt-like, it may a type such that one or two strings are disposed on each of right and left sides and an annular shape is made by knotting them together. In addition, though the power source of the embodiment is AC, it may be a type such that a battery charger is disposed in the assist device for sitting up so that it can operate in the place where no AC outlet available. In addition, though not shown in the drawings, a safety mechanism may be included like one that turns the operating switch 11 off even if the switch stays on once the nut 10 moves down to the end of the threaded rod 8 or the wire 19 gets fully stretched during operation. Though the power switch is not shown in the drawings, it may be disposed in the main body of the assist device for sitting up or may be mounted in the power cable 9 or handgrip 12.

As explained in detail in the above description, since the assist device for raising an upper body according to the present invention constitutes the main body of a sitting up assist device which has a hooking member in the front portion of a pipe member which can be hooked on the foot of a lying person or the frame or board of a bed and is equipped with an operating switch in the rear portion of the pipe member or in the handgrip in the slot, the main body of the sitting up device gets shorter or the handgrip slides ahead on turning the powering switch on. Thus, the present invention provides the assist device for sitting up device which allows not Only a weak-handed aged person but also a patient in a hospital due to serious injuries to raise his/her upper body from lying position by himself/herself. Therefore, because such a person will be able to sit up without any nearby person such as a support person, for example, to finish chores or refresh himself/herself by viewing the outdoor landscape, he/she freely lie down or sit up without any hesitation in asking for other people's help. Furthermore, it is the assist device for raising the upper body that greatly contributes to recovery from illness by substantially reducing a long-term redridden person's stress.

In addition, since the body of the sitting up device can be integrally and compactly formed by using light and tough metallic or plastic material, it can be not only made lightweight but also provided at an much lower price than an electrically-operated bed. Still further, since its operation is very easy even for an aged person, and by employing the shoulder belt of the first embodiment, the invention can widely provide a nonconventional, unique and functional assist device for raising an upper body with which even an aged or physically handicapped person of especially low power in the hands or lower back can easily sit up by himself/herself, which relieves the support person's stress and thus reduces the causes of fatigue by allowing the support person, for example, to leave his/her position for a while to finish chores or refresh himself/herself by taking a rest.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. An electrically-operated assist device for raising an upper body comprising:
a pipe member of a predetermined length, said pipe member having a handgrip or a shoulder belt;
a sliding pipe inserted into said pipe member, said sliding pipe having a hooking member in one end portion and a nut in the other end portion;
a motor disposed in one end portion of said pipe member;
a threaded rod mounted to a drive shaft of said pipe member, said threaded rod being threadably engaged with said nut; and
an operating switch for said motor.

2. An electrically-operated assist device for raising an upper body comprising:
a pipe member of a predetermined length, said pipe member having a handgrip or a shoulder belt;
a motor disposed in an end portion of said pipe member, said motor having a winch;
a sliding pipe inserted into said pipe member, said sliding pipe having a hooking member in one end portion and connected to said pipe member by a wire of said winch;
a coil spring disposed between said pipe member and said sliding pipe; and
a operating switch for said motor.

3. An electrically-operated assist device for raising an upper body comprising:
a pipe member of a predetermined length, said pipe member having a hooking member at one end;
a motor mounted to one end portion of said pipe member;
a threaded rod mounted to a drive shaft of said motor;
a nut threadably engaged with said threaded rod;
a handgrip mounted to said nut through a slot of nearly the same length of said threaded rod, said slot being formed in an upper portion of said pipe member; and
an operating switch for said motor.

4. The electrically-operated assist device for raising an upper body as in claim 1 wherein said operating switch is disposed on said pipe member.

5. The electrically-operated assist device for raising an upper body as in claim 2 wherein said operating switch is disposed on said pipe member.

6. The electrically-operated assist device for raising an upper body as in claim 3 wherein said operating switch is disposed on said nut.
